(19) United States
(12) Patent Application Publication
(10) Pub. No.: US 2017/0291551 A1
(43) Pub. Date: Oct. 12, 2017

(54) ARTICULATING, VERTICALLY HEIGHT ADJUSTABLE TAILGATE STEP FOR A MOTOR VEHICLE

(71) Applicant: GM GLOBAL TECHNOLOGY OPERATIONS LLC, Detroit, MI (US)

(72) Inventors: Gary W. Krajenke, Warren, MI (US); Derek L. Patterson, Shelby Township, MI (US); Anil A. Masih, Royal Oak, MI (US)

(21) Appl. No.: 15/093,141

(22) Filed: Apr. 7, 2016

(51) Int. Cl. B60R 3/02; B62D 33/03

(52) U.S. Cl. CPC B60R 3/02; B62D 33/03

(57) ABSTRACT

An articulating step includes a support member having a first end and a second end. A step member is pivotally connected relative to the support member. A first linkage member includes a first end portion pivotally connected to the support member, a second end portion operatively connected to the step member, and an intermediate portion extending therebetween. A first selectively adjustable cam member is operatively connected to the support member. The first selectively adjustable cam member is configured and disposed to selectively engage with the first linkage member to establish a desired spacing between the step member and the second end of the support member.

### FIELD OF THE INVENTION

The subject invention relates to the art of motor vehicles and, more particularly, to an articulating, vertically height adjustable tailgate step for a motor vehicle.

### BACKGROUND

Many motor vehicles include steps that aid passengers, drivers and the like, to enter and exit a vehicle. For example, passenger vans, pick-up trucks, and sport utility vehicles (SUV) may include a running board that helps passengers board and exit. In certain models, the running board may be deployable to help passengers avoid a particularly high first step. In addition, a pick-up truck may include a step, such as a bumper, that helps a user enter into and descend from a truck bed. While helpful, the truck bed may be arranged at a height different from that when sold by a dealer. Many users choose to add springs, lift kits and other devices to raise a truck to improve ground clearance or aesthetics. Further, step height may be limited due to chassis constraints.

Manufactures have also added a deployable step into a tailgate of certain pick-up truck models. Current deployable steps are an advance over using the bumper, but still do not address the concern of added height that might exist in certain trucks. In addition, manufacturers that offer pick-up trucks with various ground clearances may need to stock a multitude of different steps to accommodate each vehicle option. Further, existing steps, while helpful for some users, may not be adequate for others. Accordingly, it is desirable to provide a deployable tailgate step with a vertical height adjustment option to accommodate different users, different truck configurations and reduce the amount of inventory a manufacturer would need to supply and maintain.

### SUMMARY OF THE INVENTION

In accordance with an exemplary embodiment, an articulating step includes a support member having a first end and a second end. A step member is pivotally connected relative to the support member. A first linkage member includes a first end portion pivotally connected to the support member, a second end portion operatively connected to the step member, and an intermediate portion extending therebetween. A first selectively adjustable cam member is operatively connected to the support member. The first selectively adjustable cam member is configured and disposed to selectively engage with the first linkage member to establish a desired spacing between the step member and the second end of the support member.

In accordance with another aspect of an exemplary embodiment, a motor vehicle tailgate includes a body mounted to the motor vehicle. The body includes a first surface and an opposing second surface. An articulating step is arranged in the body at one of the first and second surfaces. The articulating step includes a support member having a first end and a second end. A step member is pivotally connected relative to the support member. A first linkage member includes a first end portion pivotally connected to the support member, a second end portion operatively connected to the step member, and an intermediate portion extending therebetween. A first selectively adjustable cam member is operatively connected to the support member. The first selectively adjustable cam member is configured and disposed to selectively engage with the first linkage member to establish a desired spacing between the step member and the second end of the support member.

In accordance with yet another aspect of an exemplary embodiment, a motor vehicle includes a chassis, a motor supported in the chassis, and a bed operatively associated with the chassis. The bed is provided with a tailgate having a body having a first surface and an opposing second surface. An articulating step is arranged in the body at one of the first and second surfaces. The articulating step includes a support member having a first end and a second end. A step member is pivotally connected relative to the support member. A first linkage member includes a first end portion pivotally connected to the support member, a second end portion operatively connected to the step member, and an intermediate portion extending therebetween. A first selectively adjustable cam member is operatively connected to the support member. The first selectively adjustable cam member is configured and disposed to selectively engage with the first linkage member to establish a desired spacing between the step member and the second end of the support member.

The above features and advantages and other features and advantages of the invention are readily apparent from the following detailed description of the invention when taken in connection with the accompanying drawings.

### BRIEF DESCRIPTION OF THE DRAWINGS

Other features, advantages and details appear, by way of example only, in the following detailed description of embodiments, the detailed description referring to the drawings in which:

FIG. 1 depicts a motor vehicle having a tailgate including a vertically height adjustable articulating step, in accordance with an exemplary embodiment;

FIG. 2 depicts a user entering the tailgate with the vertically height adjustable articulating step of FIG. 1;

FIG. 3 is a partially cut-away view of the vertically height adjustable articulating step in a partially deployed position;

FIG. 4. is a side view of the vertically height adjustable articulating step of FIG. 3;

FIG. 5 is a side view of the vertically height adjustable articulating step of FIG. 4 in a fully deployed position; and

FIG. 6 depicts a selectively adjustable cam member of the vertically height adjustable articulating step, in accordance with an aspect of an exemplary embodiment.

### DESCRIPTION OF THE EMBODIMENTS

The following description is merely exemplary in nature and is not intended to limit the present disclosure, its application or uses. It should be understood that throughout the drawings, corresponding reference numerals indicate like or corresponding parts and features.

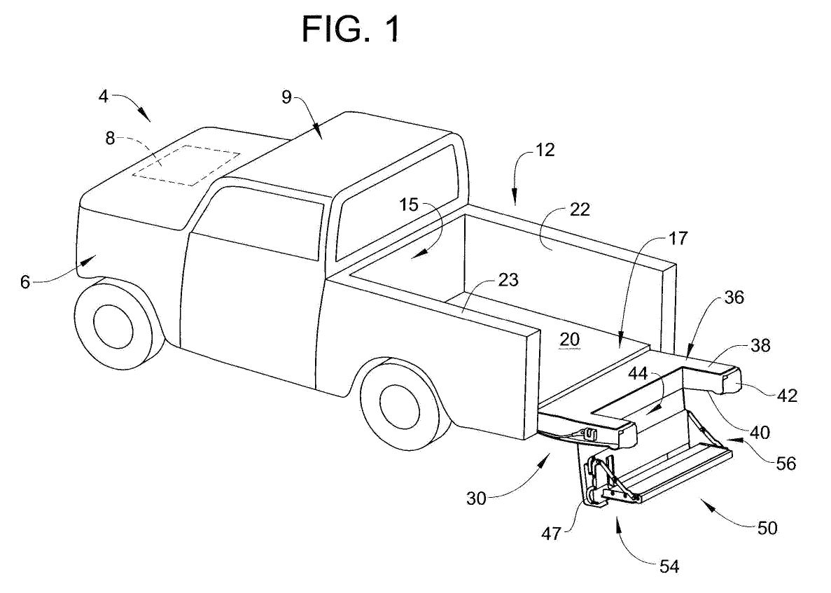

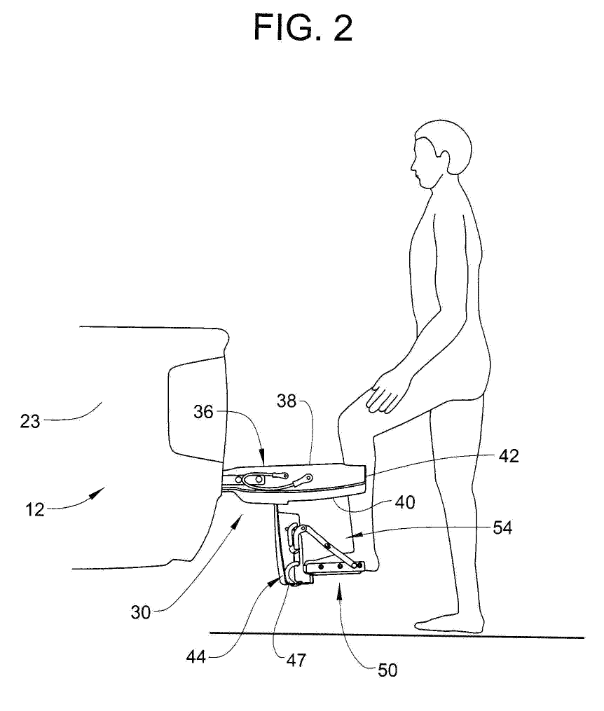

Referring to FIGS. 1 and 2, a motor vehicle, in accordance with an exemplary embodiment, is indicated generally at 4. Motor vehicle 4 includes a chassis 6 within which is supported a motor 8. As would be understood by one of ordinary skill in the art, motor 8 may take on a variety of forms including internal combustion engines which burn gasoline or diesel, hybrid engines, or electric motors. Chassis 6 also includes a passenger compartment or cab 9. In the exemplary embodiment shown, motor vehicle 10 includes a cargo bed 12 having a first end 15 arranged adjacent to cab 9, a second end 17, and a storage zone 20 extending therebetween. Cargo bed 12 also includes a first side 22 and a second, opposing side 23. First and second sides 22 and 23 extend between first end 15 and second end 17.

Cargo bed 12 includes a tailgate 30 arranged between first and second sides 22 and 23 at second end 17. Tailgate 30 includes a body 36 having a first surface 38 an opposing second surface 40 and an end portion 42. In addition, cargo bed 12 includes a mid-gate 44 formed in tailgate 30. Mid-gate 44 includes an end section 47 that substantially aligns with end portion 42 of tailgate 30. More specifically, mid-gate 44 is pivotally mounted to, and selectively deployable from, tailgate 30.

In accordance with an exemplary embodiment, motor vehicle 4 includes a vertically height adjustable, selectively deployable articulating step assembly 50. Step assembly 50 is shown incorporated into tailgate 30. More specifically, step assembly 50 may be incorporated into mid-gate 44. However, it should be understood, that step assembly 50 may be incorporated into other areas of chassis 6 including cab 9 and cargo bed 12. Further, it should be understood by those of ordinary skill in the art, that step assembly 50 need not be limited incorporation into a pick-up truck as shown in FIGS. 1 and 2 and could be arranged in other types of vehicles, including vehicles without a tailgate. Step assembly 50 includes a first linkage assembly 54 that provides an articulating interface with tailgate 30. It should be understood that a second linkage assembly 56 may be arranged on an opposing side of step assembly 50. First linkage assembly 54, as will be discussed more fully below, also provides vertical height adjustment.

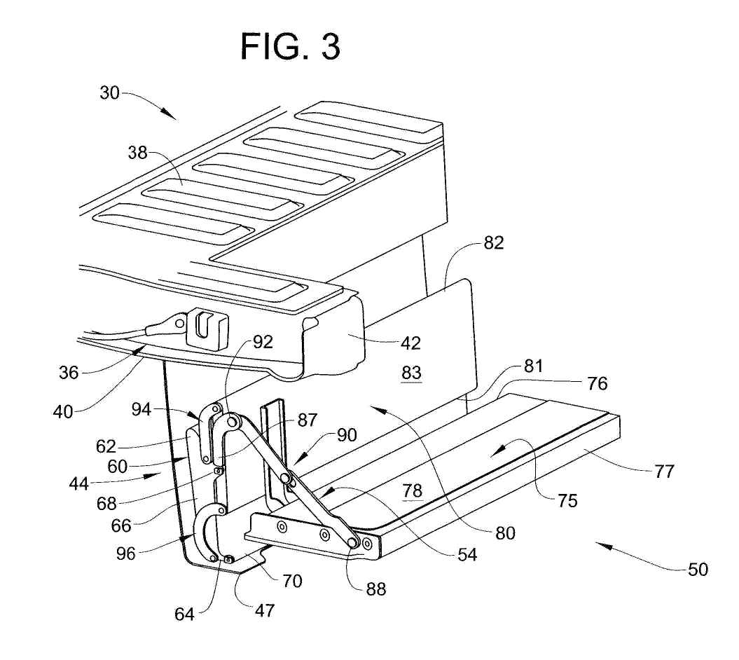

As shown in FIGS. 3-5, step assembly 50 includes a support member 60 mounted to mid-gate 44. Support member 60 includes a first end 62, a second end 64 and an intermediate zone 66. Support member 60 also includes a first protrusion 68 arranged along intermediate zone 66 near first end 62 and a second protrusion 70 arranged at second end 64. A step member 75 is pivotally mounted to support member 60. Step member 75 includes a first edge section 76, a second edge section 77 and a substantially planar surface section 78. Step assembly 50 also includes a riser 80 extending between, and operatively connected with, support member 60 and step member 75.

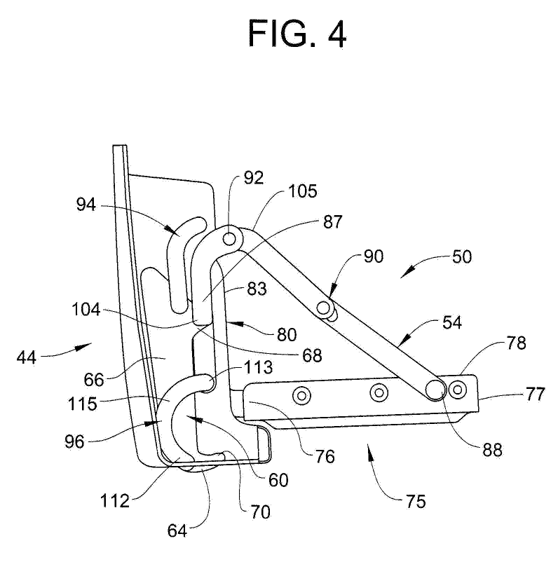

In further accordance with an exemplary embodiment, riser 80 includes a first edge 81, a second, opposing edge 82 and a substantially planar surface 83 extending therebetween. In the exemplary embodiment shown, first linkage assembly 54 is pivotally connected to step member 75 and riser 80. First linkage member 54 includes a first end 87 pivotally connected to riser 80, a second end 88 pivotally connected to step member 75 and an intermediate portion (not separately labeled) having a first hinge or joint 90 and a second hinge or joint 92. First and second joints 90 and 92 allow step member 75 to be stowed within mid-gate 44. First and second joints 90 and 92 also facilitate translation from a stowed configuration (not shown) to a partially deployed configuration as shown in FIG. 4.

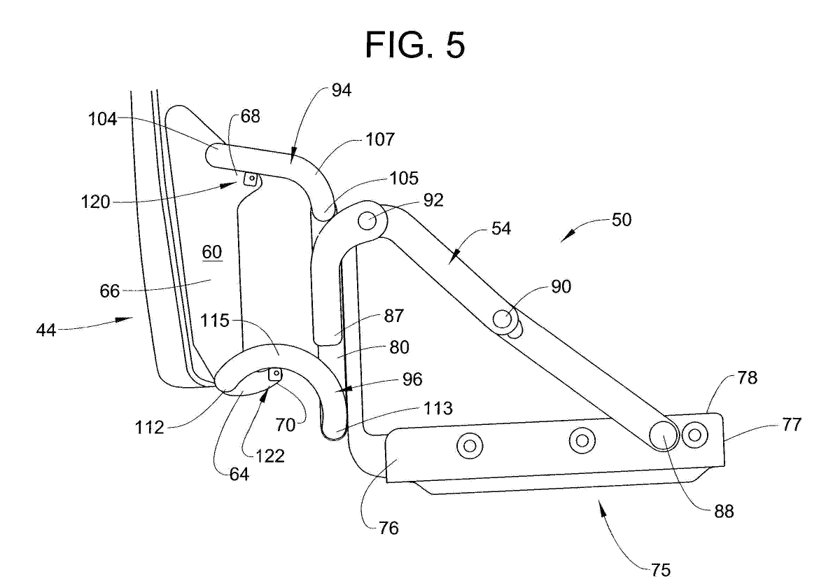

In further accordance with an exemplary embodiment, first linkage assembly 54 also includes a first linkage member 94, and a second linkage member 96 operatively connecting support member 60 and riser 80. First linkage member 94 includes a first end portion 104 pivotally connected adjacent first end 62 of support member 60, a second end portion 105 pivotally connected adjacent first edge 81 of riser 80, and an intermediate portion 107 extending therebetween. Second linkage member 96 includes a first end section 112 pivotally connected adjacent second end 64 of support member 60, a second end section 113 pivotally connected adjacent second edge 82 of riser 80, and an intermediate section 115 extending therebetween. First and second linkage members 94 and 96 facilitate a translation of step member 75 and riser 80 between the partially deployed configuration shown in FIG. 4 and a fully deployed configuration shown in FIG. 5.

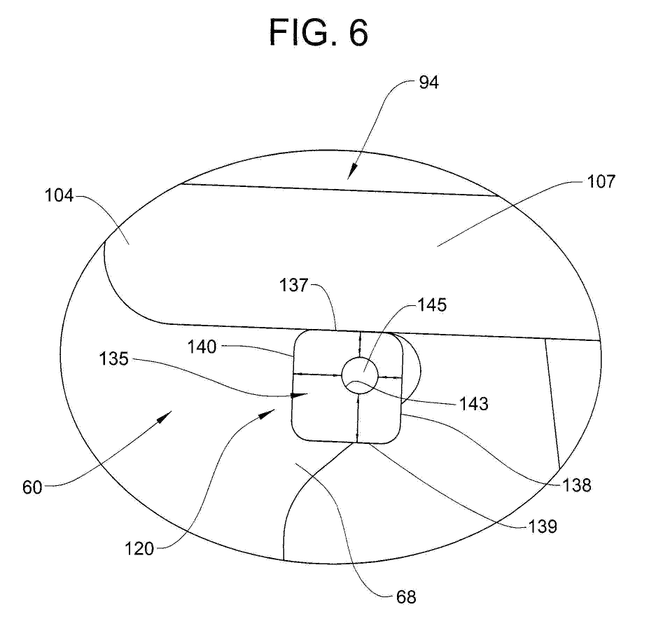

In accordance with an aspect of an exemplary embodiment, first linkage assembly 54 includes a first selectively adjustable cam member 120, FIG. 5, that facilitates vertical adjustment of step member 75 relative to support member 60. Linkage assembly 54 may also include a second selectively adjustable cam member 122 that cooperates with first selectively adjustable cam member 120 to further facilitate vertical adjustment of step member 75 relative to support member 60. First selectively adjustable cam member 120 may be mounted to first protrusion 68 of support member 60 and second selectively adjustable cam member 122 may be mounted to second protrusion 70 of support member 60. As each selectively adjustable cam member 120 and 122 may be substantially similarly formed, a detailed description will follow to FIG. 6 in describing first selectively adjustable cam member 120 with an understanding that second selectively adjustable cam member 122 may be similarly configured. It should also be understood that the second linkage assembly may also include one or more selectively adjustable cam member.

First selectively adjustable cam member 120 includes a body portion 135 having a first adjustment surface 137, a second adjustment surface 138, a third adjustment surface 139, and a fourth adjustment surface 140. Of course, it should be understood that the number of adjustment surfaces may vary. Body portion 135 also includes an opening 143 that receives a mounting pin 145. Mounting pin 145 defines an axis of rotation (not shown) for first selectively adjustable cam member 120. Opening 135 is off-set from a center of body portion 135. In this manner, each adjustment surface 137-140 is spaced a different distance from opening 135. Thus, rotation of selectively adjustable cam member 120 about mounting pin 145 provides a different amount of travel for first linkage member 94 as will be detailed below.

In accordance with an exemplary embodiment, as step member 75 translates from the partially deployed configuration (FIG. 4) and settles in the fully deployed configuration (FIG. 5) intermediate portion 107 of first linkage member 94 abuts one of adjustment surfaces 137-140 of selectively adjustable cam member 120. Depending upon the orientation of selectively adjustable cam member 120, travel of first linkage member 94 may vary. Thus, a user may selectively adjust a vertical height adjustment of step member 75 relative to support member 60 in order to accommodate his/her particular needs. At this point, it should be understood that second selectively adjustable cam member 122 may interact, in a similar manner, with second linkage member 96. It should also be understood that additional selectively adjustable cam members may be associated with the second linkage assembly. Further, it should be understood that the number and location of selectively adjustable cam members may vary.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the application.

1. An articulating step comprising:
a support member including a first end and a second end and an intermediate zone extending therebetween;
a selectively height adjustable step member pivotally connected relative to the support member;
a first linkage member including a first end portion pivotally connected to the first end of the support member, a second end portion operatively connected to the selectively height adjustable step member, and an intermediate portion extending therebetween;
a first selectively adjustable cam member operatively connected to the support member, the first selectively adjustable cam member being configured and disposed to selectively engage with the first linkage member to establish a desired spacing between the selectively height adjustable step member and the second end of the support member;
a second linkage member including a first end section pivotally connected to the second end of the support member, a second end section operatively connected to the selectively height adjustable step member and an intermediate section extending therebetween; and
a second selectively adjustable cam member mounted to the support member, the second selectively adjustable cam member being configured and disposed to selectively engage with the second linkage member to establish the desired spacing between the selectively height adjustable step member and the second end of the support member.

2. The articulating step according to claim 1, wherein the first selectively adjustable cam member is rotatably mounted to the support member.

3. The articulating step according to claim 2, wherein the support member includes a protrusion extending outwardly of the intermediate zone, the first selectively adjustable cam member being rotatably mounted to the protrusion.

4. (canceled)

5. (canceled)

6. The articulating step according to claim 1, wherein the support member includes a protrusion at the second end, the second selectively adjustable cam member being rotatably mounted to the protrusion.

7. The articulating step according to claim 1, further comprising: a hinge member extending between the selectively height adjustable step member and the support member.

8. A motor vehicle tailgate comprising:
a body mounted to the motor vehicle, the body having a first surface and an opposing second surface; and
an articulating step arranged in the body at one of the first and second surfaces, the articulating step comprising:
a support member including a first end and a second end and an intermediate zone extending therebetween;
a selectively height adjustable step member pivotally connected relative to the support member;
a first linkage member including a first end portion pivotally connected to the first end of the support member, a second end portion operatively connected to the selectively height adjustable step member, and an intermediate portion extending therebetween;
a first selectively adjustable cam member operatively connected to the support member, the first selectively adjustable cam member being configured and disposed to selectively engage with the first linkage member to establish a desired spacing between the selectively height adjustable step member and the second end of the support member;
a second linkage member including a first end section pivotally connected to the second end of the support member, a second end section operatively connected to the selectively height adjustable step member and an intermediate section extending therebetween; and
a second selectively adjustable cam member mounted to the support member, the second selectively adjustable cam member being configured and disposed to selectively engage with the second linkage member to establish the desired spacing between the selectively height adjustable step member and the second end of the support member.

9. The motor vehicle tailgate according to claim 8, wherein the first selectively adjustable cam member is rotatably mounted to the support member.

10. The motor vehicle tailgate according to claim 9, wherein the support member includes a protrusion extending outwardly of the intermediate zone, the first selectively adjustable cam member being rotatably mounted to the protrusion.

11. (canceled)

12. (canceled)

13. The motor vehicle tailgate according to claim 8, wherein the support member includes a protrusion at the second end, the second selectively adjustable cam member being rotatably mounted to the protrusion.

14. The motor vehicle tailgate according to claim 8, further comprising: a mid-gate selectively pivotal relative to the tailgate, the articulating step being arranged in the mid-gate.

15. A motor vehicle comprising:
a chassis;
a motor supported in the chassis;
a bed operatively associated with the chassis, the bed including a tailgate having a body having a first surface and an opposing second surface; and
an articulating step arranged in the body at one of the first and second surfaces, the articulating step comprising:
a support member including a first end and a second end and an intermediate zone extending therebetween;
a selectively height adjustable step member pivotally connected relative to the support member;
a first linkage member including a first end portion pivotally connected to the first end of the support member, a second end portion operatively connected to the selectively height adjustable step member, and an intermediate portion extending therebetween;
a first selectively adjustable cam member operatively connected to the support member, the first selectively adjustable cam member being configured and disposed to selectively engage with the first linkage member to establish a desired spacing between the selectively height adjustable step member and the second end of the support member;
a second linkage member including a first end section pivotally connected to the second end of the support member, a second end section operatively connected to the selectively height adjustable step member and an intermediate section extending therebetween; and
a second selectively adjustable cam member mounted to the support member, the second selectively adjustable cam member being configured and disposed to selectively engage with the second linkage member to establish the desired spacing between the selectively height adjustable step member and the second end of the support member.

16. The motor vehicle according to claim 8, wherein the support member includes a protrusion extending outwardly of the intermediate zone, the first selectively adjustable cam member being rotatably mounted to the protrusion.

17. (canceled)

18. (canceled)

19. The motor vehicle according to claim 15, wherein the support member includes a protrusion at the second end, the second selectively adjustable cam member being rotatably mounted to the protrusion.

20. The motor vehicle according to claim 15, wherein the tailgate includes a mid-gate selectively pivotal relative to the tailgate, the articulating step being arranged in the mid-gate.
